(19) United States
(12) Patent Application Publication
(10) Pub. No.: US 2024/0176296 A1
(43) Pub. Date: May 30, 2024

(54) COUPLING DEVICE FOR A TIMEPIECE

(71) Applicant: ROLEX SA, Geneva (CH)

(72) Inventors: Pierre-Alain Graemiger, Trélex (CH); Olivier Karlen, Blonay (CH)

(73) Assignee: ROLEX SA, Geneva (CH)

(21) Appl. No.: 18/518,681

(22) Filed: Nov. 24, 2023

(30) Foreign Application Priority Data
Nov. 25, 2022 (EP) 22209733.9

(51) Int. Cl. G04B 11/00; G04B 5/02

(52) U.S. Cl. CPC G04B 11/006; G04B 5/02

(57) ABSTRACT

The coupling device for a timepiece (400) includes a first part (41;41′;41″), a second part (42;42′;42″) mobile relative to the first part about a first axis (A1;A1′;A1″), at least one blocking element (43;43′;43″), and a control element (45;45′;45″) movably mounted on one of the parts to move between a deactivation first configuration (C1) and an activation second configuration (C2), the device being unidirectional or a freewheel in its activation second configuration (C2), the at least one blocking element (43;43′;43″), the first part (41;41′;41″), and the second part (42;42′;42″) being configured and/or adapted so as to connect the first and second parts by obstacle or by wedging, the at least one blocking element (43;43′;43″) being adapted and/or configured so that, in the first configuration (C1) it enables free relative movement of the first and second parts during rotation in a first direction and in a second direction opposite the first direction, and in the second configuration (C2) it enables coupling of the first and second parts during loading of one or the other in the first direction and free relative movement between the parts during rotation in the second direction.

The invention concerns a coupling device for a timepiece. The invention also concerns an automatic winding chain including a coupling device of this kind. The invention also concerns an automatic winding module including a coupling device of this kind. The invention further concerns a timepiece movement including a coupling device of this kind or an automatic winding chain of this kind or an automatic winding module of this kind. The invention further concerns a timepiece including a coupling device of this kind or an automatic winding chain of this kind or an automatic winding module of this kind or a timepiece movement of this kind. The invention finally concerns methods of operation of an automatic winding chain of this kind or an automatic winding module of this kind or a timepiece movement of this kind or a timepiece of this kind.

There is known from the document EP3489761A1 a manual winding chain for winding two barrels by means of a winding stem. The winding chain is designed in such a manner as to include an freewheel for each barrel. In a first rotation direction of the winding stem these two freewheels enable winding of a first barrel and in a second rotation direction of the winding stem for winding the second barrel. Each freewheel includes two monobloc elastic pawls intended to cooperate with gullet teeth of a ratchet connected to a barrel shaft. The particular feature of this solution is that each pawl includes a hook that enables a watchmaker to attach it to a complementary geometry so as to hold the pawl out of reach of the teeth of the ratchet 3. In this configuration the freewheel is deactivated and enables disarming of the barrel by the ratchet. Because of the multitude of pawls deactivating the freewheels can prove complex and time consuming. Moreover, the pawls must be accessible and hooking them on requires great dexterity of the watchmaker. Note that the freewheels cannot be reactivated spontaneously when winding a given barrel for example.

The document EP2226687A1 discloses an freewheel that can be deactivated arranged in an automatic winding chain. The freewheel of this solution includes two coaxial intermediate wheels with respective gullet front teeth. These two sets of front teeth are intended to cooperate with one another thanks to a spring bearing on a sliding shaft secured to an intermediate wheel. This freewheel enables a watchmaker to press on the sliding shaft so as to decouple the front teeth of the two intermediate wheels so as to deactivate the freewheel and thus enable disarming of a barrel spring by the ratchet. This solution has the disadvantage that it is relatively thick. Moreover, it is necessary for the watchmaker to maintain pressure on the sliding shaft to keep the freewheel deactivated.

In a timepiece movement an automatic winding device (or automatic winding chain) is designed both for setting a barrel spring and for keeping that spring set so that it is able to transmit the accumulated energy to the regulating member. This is guaranteed by a reversing system or a direction reverser, which, because of its intrinsic operation, prevents unwanted disarming of the barrel spring without requiring a ratchet pawl.

This is a problem for servicing a movement, in particular when it is necessary to disarm a barrel spring. With a movement of this kind it is in fact necessary to dismantle the automatic winding chain at least partially to enable disarming of the barrel spring. In addition to the stresses linked to demounting, compromises may be necessary in respect of the construction of the movement liable to increase its height or its volume, in particular with a construction provided with an automatic winding module.

The object of the invention is to provide a coupling device remedying the problems referred to above and enabling improvement of coupling devices known from the prior art. In particular, the invention proposes a simple and compact coupling device manipulation of which by a watchmaker is practical for carrying out after sales service operations.

A coupling device in accordance with the invention is defined by claim 1.

Embodiments of the coupling device are defined by claims 2 to 11.

An automatic winding chain according to the invention is defined by claim 12.

An embodiment of the automatic winding chain is defined by claim 13.

A timepiece movement in accordance with the invention is defined by claim 14.

An embodiment of the timepiece movement is defined by claim 15.

A timepiece in accordance with the invention is defined by claim 16.

The appended drawings represent by way of example three embodiments of a timepiece in accordance with the invention.

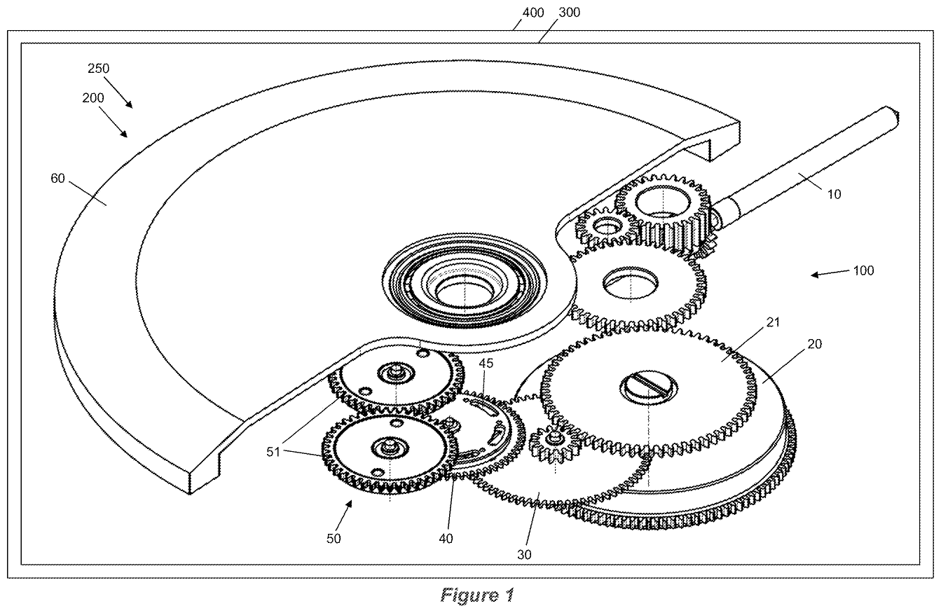

FIG. 1 is a schematic view of a first embodiment of a timepiece according to the invention.

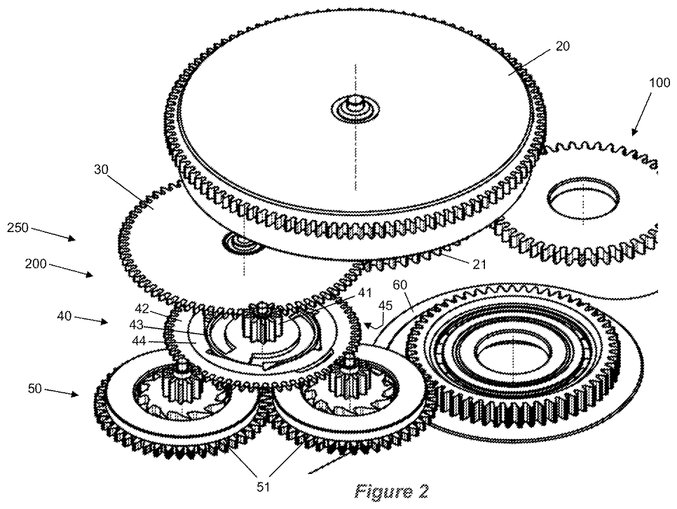

FIG. 2 is a partial perspective view of an automatic winding chain of the first embodiment.

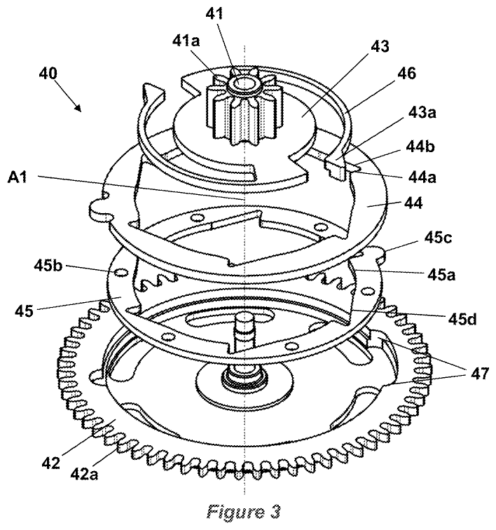

FIG. 3 is an exploded perspective view of a coupling device of the first embodiment.

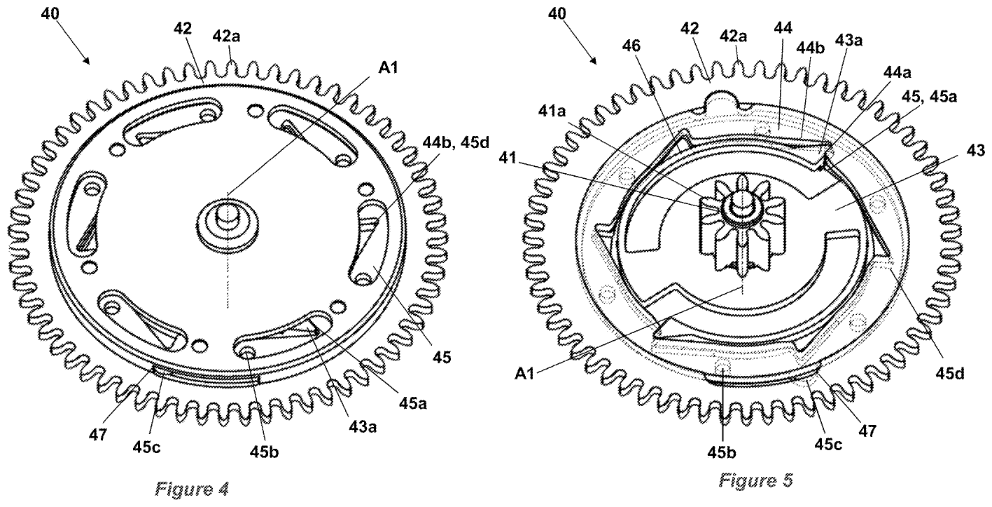

FIG. 4 is a perspective view from below of the coupling device of the first embodiment in an activated configuration.

FIG. 5 is a perspective view from above of the coupling device of the first embodiment in an activated configuration.

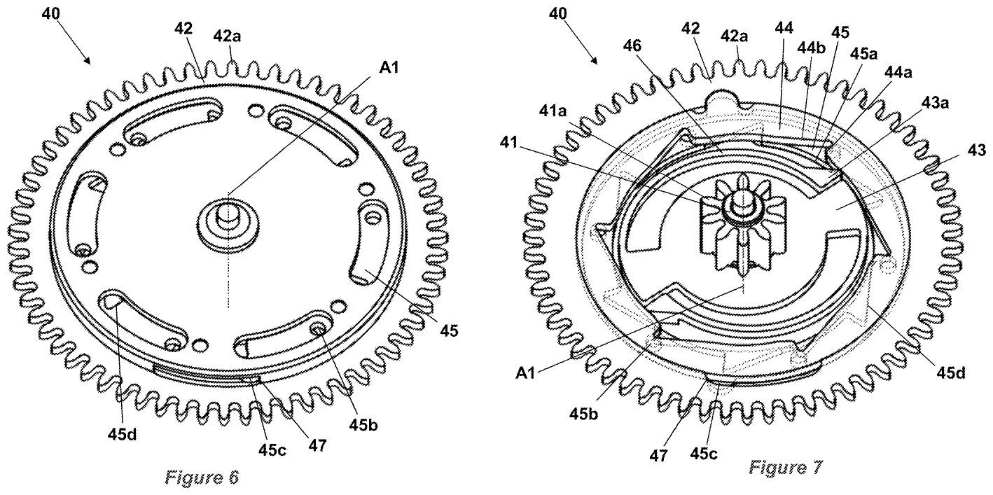

FIG. 6 is a perspective view from below of the coupling device of the first embodiment in a deactivated configuration.

FIG. 7 is a perspective view from above of the coupling device of the first embodiment in a deactivated configuration.

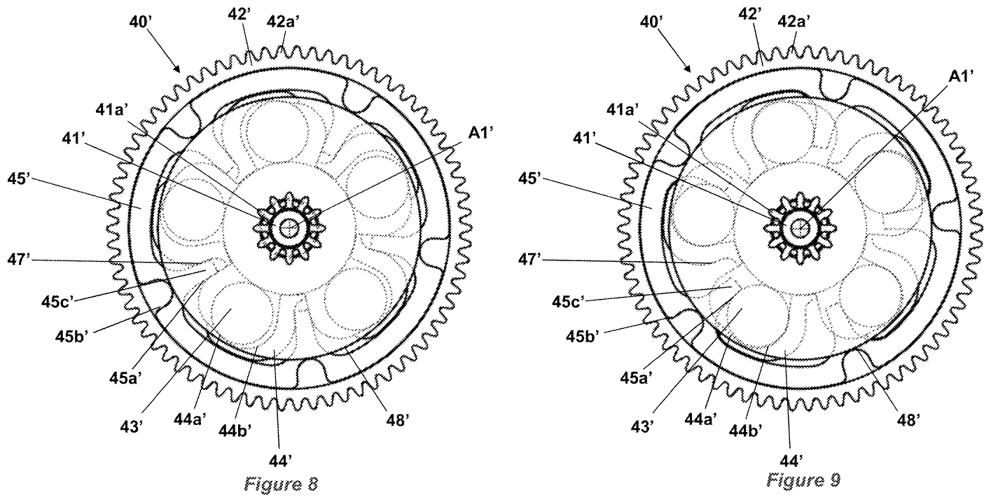

FIG. 8 is a view from above of the coupling device of a second embodiment in an activated configuration.

FIG. 9 is a perspective view from above of the coupling device of the second embodiment in a deactivated configuration.

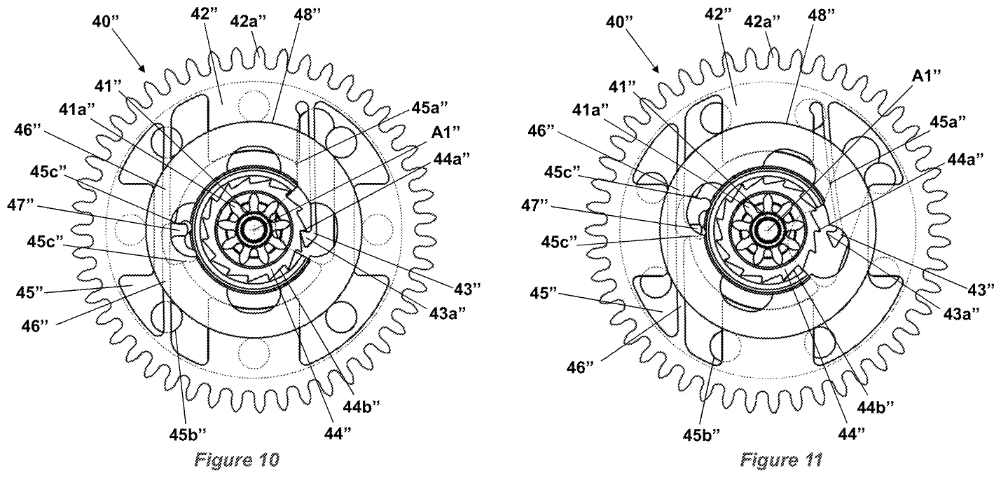

FIG. 10 is a view from above of the coupling device of a third embodiment in an activated configuration.

FIG. 11 is a view from above of the coupling device of a third embodiment in a deactivated configuration.

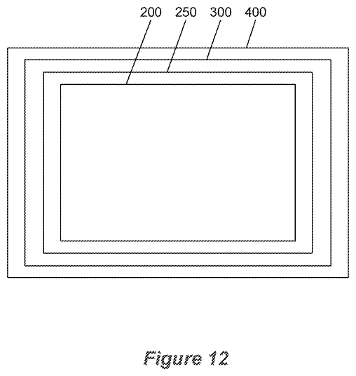

FIG. 12 is a schematic view of the first embodiment of a timepiece in accordance with the invention.

A first embodiment of a timepiece 400 is described in detail hereinafter with reference to FIGS. 1 to 7 and 12.

The timepiece 400 is for example a watch, in particular a wristwatch. The timepiece 400 includes a timepiece movement 300 intended to be mounted in a timepiece case in order to protect it from the external environment.

The timepiece movement 300 is an automatic or electromechanical movement.

The timepiece movement 300 includes an automatic winding chain 200 enabling winding of a barrel 20, that is to say enabling arming of a barrel spring 20. This automatic winding chain may be part of an automatic winding module 250 mounted on the rest of the timepiece movement, in particular an automatic winding module 250:
fixed to a plate or at least one bridge of a frame of the timepiece movement 300, and
mechanically connected to the barrel 20 of the timepiece movement 300.

The barrel spring 20 is armed or the barrel 20 is automatically wound by the recovery of energy produced by the movements of an oscillating mass 60.

The automatic winding chain 200 includes a coupling device 40.

The coupling device 40 includes:
a first part 41,
a second part 42 mobile relative to the first part about a first axis A1,
at least one blocking element 43, and moreover
a control element 45 mounted and movable on one of said parts between a deactivation first configuration C1 and an activation second configuration C2.

The first part and/or the second part is or are advantageously adapted to be mobile about the first axis A1 relative to the frame of the movement or relative to a frame of the automatic winding module 250. The first and second parts are therefore preferably arranged coaxially.

The first part 41 is advantageously a first mobile 41 and includes teeth 41a. The second part 42 is advantageously a second mobile 42 and includes teeth 42a.

The coupling device is unidirectional or an freewheel, which is to say that at least in one state or in the second configuration it enables:
immobilisation or fastening together of the first and second parts as soon as the first part tends to turn relative to the second part in a second direction, and
free rotation of the first part relative to the second part in a second direction opposite the first direction.

The at least one blocking element 43, the first part 41 and the second part 42 are configured and/or adapted to connect or to fasten together the first and second parts by constituting an obstacle or by wedging.

The at least one blocking element 43 is configured and/or adapted so that:
in the first configuration C1 (deactivated or deactivation) it allows free relative movement of the first and second parts during rotation in a first direction and during rotation in a second direction opposite to the first direction, and
in the second configuration C2 (activated or activation) it allows the first and second parts to be connected when one or the other of the parts is loaded in the first relative direction and allows free relative movement between said parts during rotation in the second relative direction.

In the first configuration C1 the first and second parts are free to move relative to one another and in the second configuration C2 the coupling device is unidirectional.

As mentioned above the coupling device 40 is preferably part of a kinematic chain for winding the barrel 20, in particular an automatic winding chain. The coupling device 40 is shaped on the one hand to transmit a torque during winding of the at least one barrel 20 and on the other hand so as momentarily to be no longer able to transmit a torque in order advantageously to enable disarming of the spring when it is deactivated by a watchmaker.

The coupling device may advantageously be deactivated (or switched to the first configuration C1) by a watchmaker so as momentarily to be no longer able to transmit a torque.

The coupling device 40 may be part of or combined with a direction reverser or a reversing system 50. The coupling device 40 is preferably arranged between a ratchet 21 of the barrel 20 and the reversing system 50 so as to disengage the latter from a manual winding chain 100 during manual winding of the barrel 20. For example, manual winding is effected by a winding stem 10 connected to the ratchet 21 by the manual winding chain 100.

This architecture as described above advantageously makes it possible in particular to preserve the reversing system 50 from any premature wear caused by the heavy loads generated by manual winding.

The coupling device preferably includes at least one first blocking element 43 adapted to cooperate with at least one second blocking element 44.

During loading in the first relative rotation direction between the first and second parts 41, 42 the at least one first blocking element 43 cooperates with the at least one second blocking element 44 so as interengage the first and second parts 41, 42 and make them rotate together. The two parts 41, 42 then turn at the same speed with the possibility of transmitting a torque. This first relative rotation direction is called an “engagement” direction.

During loading in the second relative rotation direction between the first and second parts 41, 42 the at least one first blocking element 43 is disengaged from the at least one second blocking element 44 so that the two parts 41, 42 no longer have to rotate together. The two parts 41, 42 then do not turn at the same speed and the coupling device 40 is no longer able to transmit a torque. This second relative rotation direction is called a “free” or “disengagement” direction.

Cooperation or interengagement of the first and second parts 41, 42 may be achieved using an blocking element 43 functioning:
by wedging a rolling element such as a ball, a roller or a cam against an engagement portion taking in particular the form of an inclined plane, or
by constituting an obstacle to a pawl, a set of teeth or a leaf spring cooperating with an engagement portion taking in particular the form of symmetrical or asymmetrical teeth.

By “operating by wedging” is meant that the engagement function is achieved by wedging or jamming caused by friction of rolling elements such as balls or rollers or runners or sliding elements such as cams or shape rollers.

By “operating by obstacle” is meant that the engagement function is produced by elements constituting an obstacle to one another (even in the absence of friction between these elements).

The control element 45 is advantageously a deactivation means adapted to be actuated by a watchmaker to deactivate the coupling device, that is to say to cause it to go from the second configuration C2 to the first configuration C1.

The control element 45 may have one degree of freedom of movement in rotation relative to the second blocking element 44. The control element 45 may have a relative movement or travel of predefined amplitude relative to the second blocking element 44. The control element 45 therefore enables the watchmaker to configure the coupling device 40 in two distinct configurations as a function of the relative position of the control element 45 and the second blocking element 44.

In the so-called deactivation or disengagement first configuration C1 the control element 45 is positioned so that the blocking element 43 is no longer able to cooperate with the second blocking element 44. The coupling device 40 is then deactivated so that the first and second parts 41, 42 do not have to rotate together in the first and second relative rotation directions.

In the so-called activation or engagement second configuration C2 the control element 45 is out of reach of the first blocking element 43. In this configuration the coupling device 40 functions like an freewheel and more generally like a conventional unidirectional coupling.

The control element 45 is advantageously designed to be mounted on the first part 41 or on the second part 42 and to be actuated or moved in a plane perpendicular or substantially perpendicular to the rotation axis A1 of the coupling device 40. The control element 45 is also advantageously designed to be mounted in a housing in the first part 41 or in a housing in the second part 42. Thus the control element 45 is shaped so as not to impact the height or the volume of the coupling 40 relative to that of a conventional freewheel. In other words the control element 45 is preferably inscribed within the overall size of the first part 41 or the second part 42 whatever the configuration of the coupling device 40.

The control element 45 and the second blocking element 44 are also preferably mounted on the part 41 or 42 that is not able to turn when the freewheel is in the first or deactivation configuration C1 and the barrel spring is disarmed. This makes it possible to facilitate the work of the watchmaker when a control element has to be held to deactivate the coupling device. For its part the second blocking element 44 is part of the second part. It is mounted on and fixed to the rest of the second part 42.

The coupling device 40 is advantageously adapted to be reconfigured spontaneously in the activation second configuration C2 during relative rotation in the engagement direction of one of the two parts 41 or 42. In other words the coupling device 40 is advantageously constructed so that the relative rotation in the engagement direction of the first part 41 or the second part 42 in one construction variant automatically reconfigures the freewheel in the activation second configuration C2 without external intervention, in particular without intervention of a watchmaker. This makes it possible to alleviate any malfunctions caused for example by the watchmaker forgetting to reactivate the coupling device after carrying out servicing. To this end return means may be arranged between the second blocking element 44 and the control element 45, for example elastic return means that connect the control element 45 to the second blocking element 44. As soon as the watchmaker no longer actuates the deactivation means 45 the latter are therefore spontaneously positioned out of reach of the blocking element 43.

The return means may be formed on the blocking element 43. For example, the return means may be an elastic arm 46 of the blocking element 43 that is designed to generate friction between said blocking element 43 and the control element 45. This friction enables the blocking element 43 to drive and to position the control element 45 so as to reconfigure the coupling device 40 in the second configuration C2 following rotation in the engagement direction of the first part 41 or alternatively of the second part 42. Of course, the friction torque generated by the return means 46 must be greater than the torque necessary to rotate the control element 45 facing the second blocking element 44.

Alternatively, the return means may consist in a spring urging rotation of the control element 45 to one of the ends of its travel relative to the second blocking element 44.

In the embodiment which is depicted in FIGS. 1 to 7 the coupling device 40 is for example directly engaged with the reversing system 50 of the automatic winding chain 200. The second mobile 42 is more particularly directly engaged via its teeth 42a with two pawl freewheels 51 constituting the reversing system 50. Here the coupling device 40 is designed to disengage the reversing system 50 during manual winding.

In the second configuration the coupling device 40 takes the form of an freewheel with elastic pawls comprising a first part 41 adapted to pivot relative to and coaxially with the second part 42.

As depicted in particular in FIGS. 2 and 3 the first part 41 includes a pinion 41a secured to the first blocking element 43. The first blocking element 43 is also an elastic pawl 43 having at least one beak 43a on at least one elastic arm 46, in particular at one end of an elastic arm 46.

With its teeth 42a the second part 42 constitutes a second mobile. The second part further includes the second blocking element 44. This second blocking element 44 includes an internal cut-out with an asymmetrical geometry internal sawtooth profile 44b. This profile is intended to cooperate with the at least one beak 43a. In fact, the at least one beak is designed to come to be accommodated in the recesses formed by the tips of the aforementioned teeth. The pawl 43 then cooperates with the second blocking element 44 so that in the first direction of relative rotation of the first and second parts (engagement direction) the beak 43a is accommodated and braced in a recess 44a of the internal profile 44b constituting an obstacle to it, thereby engaging the first and second parts 41, 42.

In the second direction of relative rotation of the first and second parts (free direction), thanks to the elasticity of the pawl 43 and the respective shapes of the internal teeth 44b and the beak 43a, the latter escapes from the recesses 44a of the internal teeth 44b, disengaging the two parts 41, 42.

The control element 45 of the coupling device 40 is preferably arranged coaxially with the parts 41, 42, more particularly in a housing of the second part 42, between the teeth 42a and the second blocking element 44 in a direction parallel to the axis A1. Said control element includes a cut-out or an internal profile 45d having a geometry similar to that of the internal profile 44b of the second blocking element 44.

In the second part 42 the control element 45 may advantageously adopt at least two distinct angular positions about the axis A1 relative to the second blocking element 44 in order to configure the coupling device 40 in the first or second configuration C1, C2.

Modification of the configuration is in particular possible thanks to a deactivation portion 45a taking the form, in this embodiment, of a substantially cylindrical portion of the control element 45, in particular in the control element 45. The deactivation portion 45a is arranged between two recessed teeth of the internal profile 45d. As described in more detail hereinafter said portion is adapted to disengage the beak 43a from the engagement portion 44a in order to deactivate the coupling device 40, i.e. to switch it to the first configuration. The deactivation portion 45a is therefore adapted to act, in particular through contact, with the at least one blocking element 43 in order for it not to cooperate with the first or second part in the first configuration.

The control element 45 preferably includes at least one actuation portion 45b which, by means of a tool, enables the watchmaker to configure the control element in at least the first configuration C1, or even additionally in the second configuration C2. Here the actuating portion takes the form of holes or notches or openings 45b machined in the control element 45. These holes or notches 45b are accessible to the watchmaker, for example through openings in the second part 42, preferably without even partial demounting of the timepiece movement being necessary.

The angular relative movement of the control element 45, in particular relative to the second part 42, to go from the first configuration to the second or vice versa, is preferably limited by a portion or tongue 45c adapted to cooperate with abutments 47 machined in the second part 42.

During automatic winding the coupling device 40 is in the activation second configuration C2 as represented in FIGS. 4 and 5 so as to enable arming of the spring of the barrel 20 by the movements of the oscillating mass 60. In this configuration the arming torque is transmitted from the teeth 42a to the pinion 41b via cooperation of the beak 43a of the pawl with the internal profile 44a of the second blocking element 44.

In the activation second configuration C2 the internal profile 45d is substantially superimposed on the internal profile 44b of the second blocking element 44 so that the latter can have at least one engagement portion 44a facing the beak 43a. Consequently the deactivation portion 45a of the control element 45 is out of reach of the beak 43a. Here the coupling device 40 functions like a conventional unidirectional coupling.

During manual winding the first part 41 is driven in the free direction (the anticlockwise direction in FIG. 5) and is disengaged from the second part 42 by the pawl 43 which escapes from or is disengaged from the second blocking element 44, or more particularly the asymmetrical internal profile of the second blocking element 44.

To be able to disarm the springs of the barrel 20 it is necessary for the first part 41 to be able to turn in the first engagement direction (the clockwise direction in FIG. 5). However, rotation of the second part 42 in this direction is locked by the intrinsic operation of the reversing system 50, consequently preventing disarming of the barrel 20.

By configuring the coupling device 40 in the deactivation first configuration C1 the coupling device 40 is advantageously deactivated and is no longer able to transmit torque between the two parts 41, 42, whatever their relative rotation direction.

The coupling device 40 advantageously alone suffices when it is in the deactivation first configuration C1. In other words, there is no need for a watchmaker to continue to hold the coupling device 40 in the deactivation first configuration C1.

To reach this configuration represented in FIGS. 6 and 7, a watchmaker actuates the control element 45 via the portion 45b so as to move it relative to the second blocking member 44. By this action the deactivation portion 45a is positioned in line with the engagement portion 44a facing the beak 43a, so as to generate a substantially cylindrical interior profile facing the beak. The beak 43a is therefore held out of reach of the engagement portion 44a. In other words, in this first configuration C1 the result of the superimposition of the control element 45 with the second blocking element 44 is an internal profile with no engagement portion, in this instance a substantially cylindrical interior profile. The coupling device 40 is then no longer activated and the first part 41 is completely free to turn in both rotation directions relative to the second part 42.

For the coupling device 40 to be activated again the watchmaker can simply reconfigure the coupling device 40 in the second configuration C2 by actuating the control element 45 in a direction opposite to that enabling the first configuration C1 to be achieved.

In this embodiment the coupling device 40 is advantageously also designed to be spontaneously reconfigured in the activation second configuration C2 during manual winding. To achieve this the elasticity of the arm 46 of the pawl 43 is exploited to generate friction between the beak 43a and the deactivation portion 45a when the coupling device 40 is in the first configuration C1. In fact, during manual winding in the first configuration C1 the first part 41 turns in the free second direction (the anticlockwise direction in FIG. 7). Consequently, thanks to said friction the beak 43a tends to drive the control element 45 (relative to the second part 42) so as to configure the coupling device 40 in the activation second configuration C2. Accordingly, even if a watchmaker has left the coupling device 40 in the deactivation first configuration C1 when returning the timepiece movement to the case, it is still possible to reconfigure the coupling device 40 in the activation second configuration C2 by action on the winding stem 10.

During disarming of the barrel spring in the deactivation first configuration C1 the first part 41 turns in the engagement first direction (the clockwise direction in FIG. 7). Through friction against the deactivation portion 45a, the beak 43a advantageously tends to drive the control element 45 into or to maintain it in abutting engagement so as to maintain the coupling device 40 in the deactivation first configuration C1.

It must be remembered that when the coupling device 40 is in the activation second configuration C2 the deactivation portion 45a is out of reach of the beak 43a. Consequently, the latter is not able to act on the control element 45 and it is impossible for the coupling device 40 to be spontaneously configured in the deactivation first configuration C1.

A second embodiment of the timepiece is described in detail hereinafter with reference to FIGS. 8 and 9.

The timepiece is for example a watch, in particular a wristwatch. The timepiece includes a timepiece movement intended to be mounted in a timepiece case in order to protect it from the external environment.

The timepiece movement is an automatic or electromechanical movement.

The timepiece movement includes an automatic winding chain for winding a barrel, i.e. for arming a spring of the barrel. This automatic winding chain may be included in an automatic winding module mounted on the rest of the timepiece movement, in particular an automatic winding module:
fixed to a plate or at least one bridge of a frame of the timepiece movement, and
mechanically connected to the barrel of the timepiece movement.

Automatic winding or arming of the barrel is the result of recovery of the energy supplied by the movements of an oscillating mass.

The automatic winding chain includes a coupling device 40′.

In this second embodiment the references of elements having structures and/or functions identical or similar to those of elements of the first embodiment are deduced from the references of those elements of the first embodiment by adding a prime symbol (′).

This second embodiment preferably differs from the first embodiment only in that:
the first blocking element 43′ is a roller 43′ disposed at the interface of the first and second parts 41′, 42′, and
the second blocking element 44′ includes a housing 44b′ machined in the second part 42′, the housing 44b′ including an engagement portion 44a′ taking the form of an inclined plane 44a′ (that is to say a plane parallel to the axis A1′ but at a non-zero angle, for example an angle of a few degrees, to the direction orthoradial to the axis A1′).

The roller 43′ more particularly takes its place in the housing 44b′. The inclined plane 44a′ makes it possible to wedge (see FIG. 8) the roller 43′ against a cylindrical portion of the first part 41′ in the engagement first direction (the direction of clockwise rotation of the first part 41′ in FIG. 8).

In this free second direction (the direction of anticlockwise rotation of the first part 41′ in FIG. 8) the roller 43′ is moved in the housing 44b′ so as to be disengaged from the inclined plane 44a′, thereby disengaging the two parts 41′, 42′ (as represented in FIG. 9).

In this second embodiment the control element 45′ is mounted on the second blocking element 44′ and is able to pivot coaxially with the latter about the axis A1′. The control element 45′ is intended to assume at least two positions about the axis A1′ relative to the second blocking element 44′. As in the first embodiment said control element enables configuration of the coupling device 40′ in the first and second configurations C1, C2 thanks a deactivation portion 45a′ adapted to act on the rollers 43′.

The deactivation portion 45a′ is more particularly intended in the deactivation first configuration C1 to push and to hold the roller 43′ out of reach of the portion of the inclined plane 44a′ designed to wedge the roller 43′ against the cylindrical portion of the first part 41′.

In the activation second configuration C2 the deactivation portion 45a′ is positioned in the second blocking element 44′ so as to be out of reach of the roller 43′. The coupling device 40′ then functions like a conventional unidirectional coupling, in particular like a roller type freewheel.

The angular relative movement of the control element 45′ is preferably limited by an abutment 47′ machined in the second blocking element 44′ and intended in the activation second configuration C2 to cooperate with an abutment portion 45c′ of said control element 45′.

The control element 45′ may be actuated by a watchmaker by means of actuation portions 45b′, in particular notches 45b′.

In this second embodiment, to be able to disarm the spring of the barrel 20, the watchmaker actuates and holds the control element 45′ so as to configure the coupling device 40′ in the deactivation first configuration C1. The first part 41′ is then able to turn in the engagement first direction (the clockwise direction in FIG. 9) without driving the second part 42′.

In this embodiment the coupling device 40′ is spontaneously reconfigured in the activation second configuration C2 during automatic winding. In fact, when the teeth 42a′ are driven in the engagement first direction the roller 43′ tends to come to be wedged between the inclined plane 44a′ and the cylindrical portion of the first part 41′, drawing the control element 45′ with it toward the position in which it does not allow deactivation of the coupling device 40′.

Friction between the roller 43′ and the first part 41′ can facilitate spontaneous reconfiguration of the coupling device 40′ in the activation second configuration C2. The friction may be generated by elastic means (not represented) pressing axially on the roller 43′ so as to favour its relative movement with the second blocking element 44′. More generally, said friction may be generated between the roller 43′ and one of the two parts 41′, 42′ not including the second blocking element 44′.

Elastic return means (not represented) are adapted to urge the deactivation control element 45′ elastically toward the activation second configuration C2 can also be arranged between the latter and the second blocking element 44′.

A third embodiment of a timepiece is described in detail hereinafter with reference to FIGS. 10 and 11.

The timepiece is for example a watch, in particular a wristwatch. The timepiece includes a timepiece movement intended to be mounted in a case of the timepiece in order to protect it from the external environment.

The timepiece movement is an automatic or electromechanical movement.

The timepiece movement includes an automatic winding chain for winding a barrel, i.e. for arming a spring of the barrel. This automatic winding chain may be included in an automatic winding module mounted on the rest of the timepiece movement, in particular an automatic winding module:
fixed to a plate or at least one bridge of a frame of the timepiece movement, and
mechanically connected to the barrel 20 of the timepiece movement.

Automatic winding or arming of the barrel is the result of recovery of the energy supplied by the movements of an oscillating mass.

The automatic winding chain includes a coupling device 40″.

In this third embodiment the references of elements having structures and/or functions identical or similar to those of elements of the first embodiment are deduced from the references of those elements of the first embodiment by adding a seconds symbol (″).

This third embodiment preferably differs from the first embodiment only in that:
the second blocking element 44″ is a set of gullet teeth 44b″, the teeth being for example secured on the first part 41″,
the first blocking element 43″ is a pawl including a flexible blade ending in a beak 43a″ intended to cooperate with the gullet teeth 44b″, the pawl being for example secured to the second part 42″.

The control element 45″ is for example a ring featuring:
a guide for pivoting thereof relative to the second part 42″ about the axis A1″,
two notches 45c″ for defining two stable positions of the control element 45″ relative to the second part 42″, and
a support or beak 45a″ for exerting a bending action of the pawl 43″ in order to deactivate this pawl 43″.

The second part 42″ includes a spring 46″, in particular a leaf spring having a beak or nipple 47″ cooperating with the notches 45c″ to define the two stable positions of the control element 45″ relative to the second part 42″.

The second blocking element 44″ more particularly cooperates with the first blocking element 43″ in the engagement first direction (the rotation direction of the first part 41″ in the clockwise direction in FIG. 10).

In the free second direction (the rotation direction of the first part 41″ in the anticlockwise direction in FIG. 10) the inclined planes of the gullet teeth act on the beak 43a″ to retract it by causing the blade of the pawl to bend. The two parts 41″, 42″ are therefore disengaged.

As mentioned above, in this third embodiment the control element 45″ is mounted on the second part 42″ and is able to pivot coaxially with the latter about the axis A1″. The control element 45″ is intended to assume at least two angular positions about the axis A1″ relative to the first blocking element 43″. As in the first embodiment, said control element enables configuration of the coupling device 40″ in the first and second configurations C1, C2 thanks to a deactivation portion 45a″ adapted to act on the pawl 43″.

In the deactivation first configuration C1 the deactivation portion 45a″ more particularly acts on the pawl 43″ as represented in FIG. 11.

As represented in FIG. 10, in the activation second configuration C2 the deactivation portion 45a″ does not act on the pawl 43″.

The angular relative movement of the control element 45″ is preferably limited by the notches 45c″.

The control element 45″ can be actuated by a watchmaker by means of actuation portions 45b″, in particular notches 45b″.

In this third embodiment, to be able to disarm the barrel spring the watchmaker actuates the control element 45″ so as to configure the coupling device 40″ in the deactivation first configuration C1. This configuration is stable because the nipple 47″ is located in a given notch 45″. The first part 41″ can then turn in the engagement first direction without driving the second part 42″.

In this embodiment the coupling device 40″ is not spontaneously reconfigured in the activation second configuration C2 during automatic winding. The watchmaker therefore actuates the control element 45″ so as to configure the coupling device 40″ in the activation first configuration C2. This configuration is stable. The first part 41″ then turns in the engagement first direction, driving the second part 42″.

The solutions described above relate to an automatic winding chain. However, these solutions may more generally be applied to any timepiece mechanism liable to necessitate a coupling that can advantageously deactivated and no longer allow transmission of torque.

As an alternative to the embodiments described above the coupling device may for example form part of a reversing system, of a direction reverser, or be arranged in a manual winding chain between a winding stem and at least one barrel.

In the various solutions described above, in its activated configuration the coupling device provides unidirectional transmission. As an alternative, in this activated configuration the coupling device may provide bidirectional transmission, that is to say enable transmission of torque in both rotation directions.

In the first and second embodiments described above the first configuration C1 is an unstable configuration and the second configuration C2 is a stable configuration. It is nevertheless possible to obtain a stable first configuration C1 in the first and second embodiments by modifying the return element.

In the third embodiment described above the first configuration C1 is a stable configuration and the second configuration C2 is a stable configuration. It is nevertheless possible to obtain an unstable first configuration C1 in the third embodiment by modifying the return element.

By “unstable configuration” is meant that the coupling device leaves this unstable configuration:
during subsequent winding of the barrel (by the oscillating mass or by the winding stem), and/or
when a watchmaker ceases to exert an action continuously on the control element to maintain the coupling device in the unstable configuration.

The term “unstable configuration” therefore does not necessarily mean that a watchmaker must exert a continuous action on the control element to maintain the coupling device in the unstable configuration. In fact, this unstable position is preferably maintained even in the absence of continuous action by the watchmaker on the control element.

By “stable configuration” is meant a configuration of the coupling device that is permanent and that can only be changed by an action on the control element by a watchmaker.

In the first and second embodiments described above the coupling device 40; 40′ includes a return element biasing the control element 45; 45′ toward the second configuration. The return element is preferably configured and/or adapted to move the control element 45; 45′ into the second configuration from the first configuration because of the effect of:
either relative movement between the first and second parts in the first direction,
or relative movement between the first and second parts in the second direction.

The return element may comprise a friction surface of the blocking element 43; 43′ acting directly or indirectly by friction on the control element 45; 45′. In addition to this or instead of this the return element may be or include an elastic return element.

In the various embodiments described:
the first part 41; 41′; 41″ may be part of a first mobile including teeth, in particular a pinion 41a; 41a′; 41a″, and/or
the second part 42; 42′; 42″ may be part of a second mobile including teeth, in particular a wheel 42a; 42a′; 42a″.

The first mobile or the second mobile preferably includes the control element 45; 45′; 45″.

In the various embodiments holding portions 45b; 45b′; 45b″ are provided so as to enable a watchmaker to manipulate the control element, in particular using a tool. The portions described are holes, notches or openings. Any other conformation is envisaged, however.

In the various embodiments described the control element 45; 45′; 45″ is mounted on the first or second part that is only connected to the barrel via the at least one blocking element 43; 43′; 43″.

As a consequence of the solutions described above, one embodiment of a method of operating an automatic winding chain 200 or an automatic winding module 250 including a coupling device 40 as referred to above is described hereinafter.

The operating method includes the following steps:
when the coupling device 40 is in the first configuration C1, actuation of the automatic winding chain 200, and
as a consequence of that actuation or following that actuation, a change from the first configuration C1 to the second configuration C2.

As a consequence of the solutions described above, one embodiment of a method of operating a timepiece movement 300 or a timepiece movement 400 including a coupling device 40; 40′ as referred to above is described hereinafter.

The operating method includes the following steps:
while the coupling device 40; 40′ is in the first configuration C1, actuation of the automatic winding chain 200, and
as a consequence of this actuation or following this actuation, a change from the first configuration C1 to the second configuration C2.

As an alternative to this or in addition to this the operating method includes the following steps:
while the coupling device 40; 40′ is in the first configuration C1, actuation of the winding chain 100, and
as a consequence of this actuation, a change from the first configuration C1 to the second configuration C2.

The solutions described above advantageously enable disarming of a barrel spring without even partial demounting of the automatic winding chain. The proposed solutions therefore make it possible to dispense with a modular construction of the automatic winding chain at the same time as offering simplification of the manipulations for disarming the barrel.

The proposed solutions relate to a winding chain including a coupling device that can advantageously be deactivated by a watchmaker so as no longer to be functional. Alternatively, the coupling device may be deactivated by another subsidiary device (arranged in the movement). The coupling device can therefore no longer be able to transmit torque to the winding chain without disassembling the movement and enables disarming of the barrel spring.

Advantageously, as explained above, and preferably, after it has been deactivated the coupling device is adapted to be reset spontaneously, without external intervention, in an activated or functional configuration during subsequent winding.

The coupling device solutions described above advantageously have the same overall size, in particular the same diameter and/or the same thickness, in the first configuration and in the second configuration. The coupling device solutions described above preferably have the same overall size, in particular the same diameter and/or the same thickness, in all the intermediate configurations between the first and second configurations.

In the present document by the term “module” is meant an autonomous assembly, namely an assembly sufficient in itself and enabling assembly or retention, in particular pivoting, of elements independently of:
the frame of the timepiece movement in which or on which it is to be mounted, or
any other module in said movement.

Whatever the embodiment or variant, the control element is preferably separate from the first and second parts and from the locking elements.

Whatever the embodiment or variant, the first configuration C1 is not a disassembled or partially disassembled configuration of the coupling device, in particular a configuration in which the locking elements are removed.

Whatever the embodiment or variant, in the second configuration C2, the coupling device enables the first and second parts to be connected when one and/or other of the parts is urged to a relative rotation in the first direction and allows free relative rotation between the said parts during relative rotation in the second direction. The connection of the first and second parts when one and/or other of the parts is urged to a relative rotation in the first direction does not exclude a slight free relative movement, typically to catch up a clearance angle or a dead angle, between the said parts during relative rotation in the first direction over a small angular amplitude, for example an angular amplitude of less than 360°, in particular less than 90°, or even less than 15°, or even less than 10°.

1. A coupling device for a timepiece, including:
a first part,
a second part rotatably mobile relative to the first part about a first axis,
at least one blocking element, and
a control element movably mounted on one of the first and second parts to move between a deactivation first configuration and an activation second configuration,
the coupling device being unidirectional or being a freewheel in the second configuration of the control element,
the at least one blocking element, the first part and the second part being adapted to connect the first and second parts by obstacle or by wedging,
the at least one blocking element being adapted so that:
in the first configuration the at least one blocking element enables free relative movement of the first and second parts in a first direction and in a second direction opposite the first direction, and
in the second configuration the at least one blocking element enables coupling of the first and second parts when one and/or other of the parts is urged to a relative movement in the first direction and enables free relative movement of the first and second parts in the second direction.

2. The coupling device according to claim 1, wherein the control element is mobile in rotation about the first axis between the first and second configurations.

3. The coupling device according to claim 1, wherein the first configuration is a stable configuration and the second configuration is a stable configuration.

4. The coupling device according to either claim 1, wherein the first configuration is an unstable configuration and the second configuration is a stable configuration.

5. The coupling device according to claim 4, wherein the coupling device includes a return element urging the control element toward the second configuration.

6. The coupling device according to claim 5, wherein the return element is adapted to move the control element into the second configuration from the first configuration because of an effect:
either of relative movement between the first and second parts in the first direction,
or of relative movement between the first and second parts in the second direction.

7. The coupling device according to claim 6, wherein the return element includes a friction surface of the blocking element acting directly or indirectly by friction on the control element.

8. The coupling device according to claim 5, wherein the return element is an elastic return element.

9. The coupling device according to claim 1, wherein the control element includes a portion adapted to act on the at least one blocking element in order for the at least one blocking element not to cooperate with either the first or second part.

10. The coupling device according to claim 1, wherein the control element includes a holding portion adapted to allow a watchmaker to manipulate the control element.

11. The coupling device according to claim 1, wherein the blocking element includes at least one elastic lever ending in a beak, and the first or second part includes:
a ring including a cut-out, against which the beak acts, or
teeth.

12. An automatic winding chain or automatic winding module including a barrel, a winding mobile mass and a coupling device according to claim 1.

13. The automatic winding chain or automatic winding module according to claim 13, including a coupling device according to claim 1, the control element being mounted on the first or second part that is only connected to the barrel via the at least one blocking element.

14. A timepiece movement including a coupling device according to claim 1.

15. The timepiece movement according to claim 14, including a manual winding chain, the coupling device being adapted to go from the first configuration to the second configuration as a consequence of:
actuation of the automatic winding chain, or
actuation of the winding chain.

16. A timepiece
including a timepiece movement according to claim 14.

17. The coupling device according to claim 9, wherein the portion of the control element is adapted to act through contact on the at least one blocking element in order for the at least one blocking element not to cooperate with either the first or second part.

18. The coupling device according to claim 10, wherein the holding portion of the control element is adapted to allow the watchmaker to manipulate the control element using a tool.

19. The coupling device according to claim 11, wherein the blocking element includes two elastic levers ending in beaks, and the first or second part includes the ring including the cut-out, against which the beaks act.

20. The coupling device according to claim 11, wherein the blocking element includes two elastic levers ending in beaks, and the first or second part includes external teeth and/or gullet teeth.
